(19) United States
(12) Patent Application Publication
(10) Pub. No.: US 2011/0055213 A1
(43) Pub. Date: Mar. 3, 2011

(54) QUERY EXTRACTING APPARATUS, QUERY EXTRACTING METHOD AND QUERY EXTRACTING PROGRAM

(75) Inventors: Hiromi Ishizaki, Fujimino-shi (JP); Keiichiro Hoashi, Fujimino-shi (JP); Yasuhiro Takishima, Fujimino-shi (JP)

(73) Assignee: KDDI Corporation, Tokyo (JP)

(21) Appl. No.: 12/851,525

(22) Filed: Aug. 5, 2010

(30) Foreign Application Priority Data
Aug. 28, 2009 (JP) 2009-197920

(51) Int. Cl. G06F 17/30

(52) U.S. Cl. 707/737; 707/769; 707/E17.089; 707/E17.014

(57) ABSTRACT

To provide a query extracting apparatus, query extracting method and query extracting program capable of retrieving an image that is suited to a part of lyrics while also having suitability for the other parts, a query extracting apparatus 100 to retrieve images suited to lyrics divides lyrics targeted for query extraction into a plurality of segments, determines a preferential segment in which a keyword group is preferentially selected from among the segments, and selects a keyword group to retrieve an image suited to lyrics of the preferential segment while also referring to information of one or more segments. By this means, keywords suited to the preferential segment are preferentially selected, while also referring to the other segments to extract an image retrieval query, and it is thus possible to retrieve an image that is suited to a part of the lyrics while also having suitability for the other parts.

### BACKGROUND OF THE INVENTION

1. Field of the Invention

The present invention relates to a query extracting apparatus, query extracting method and query extracting program to retrieve images suited to lyrics.

2. Description of Related Art

Apparatuses have conventionally been known which reproduce images and music in synchronization with each other. An image reproduction apparatus as described in Japanese Unexamined Patent Publication No. 2006-164229 reproduces BGM suited to the shooting time of images to reproduce in reproducing the images shot by a digital camera in a slide show, and thereby further enhances the picture appreciative effect. Then, based on the images, the apparatus retrieves music to automatically add BGM. The music is retrieved by matching the release date of the song, dates of a period during which the song was ranked the highest in popular ranking or the like with the shooting time.

A music distribution server as described in Japanese Unexamined Patent Publication No. 2002-73049 selects music stored in a database of the server in reproducing music, and designates items such as lyrics, commentary, and images to display in synchronization with the music. Then, the server writes a time interval for synchronization reproduction in a header of the music to transmit together with the music to a terminal, and the music and the other information is thereby reproduced in synchronization with each other.

A portable information terminal as described in Japanese Unexamined Patent Publication No. 2008-8954 extracts lyrics by voice recognition in reproducing music, and further extracts keywords from the extracted lyrics based on a predetermined rule. Then, based on the keywords, the terminal retrieves images from local storage and/or Web pages on the Internet to display the images in reproducing the music.

For example, the predetermined rule is a rule such that an extracted keyword is a word which is used the most frequently among words of lyrics within a given set period, another rule such that a extracted keyword is a word vocalized the most loudly among words of lyrics within a given set period, or still another rule such that a keyword is a word randomly selected from a plurality of words within a given set period.

In the portable information terminal as described in Japanese Unexamined Patent Publication No. 2008-8954, when the terminal retrieves images using Web pages on the Internet as a retrieval destination, the terminal retrieves images by using a search engine on the Internet or the like using a keyword. Moreover, in the case of searching Web pages on the Internet, the apparatus is also able to perform filtering processing to prevent undesired images from being retrieved, and/or filtering processing to retrieve, for example, only images of a desired genre, etc.

In addition, the filtering processing can be performed not only in conducing image retrieval via the Internet, but also, for example, in extracting a keyword. In this case, it is possible to perform filtering processing of not extracting a keyword with a high possibility that an undesired image is retrieved, and inversely, for example, filtering processing of extracting only a keyword with a high possibility that an image of a desired genre or the like is retrieved.

An image presenting apparatus as described in Japanese Unexamined Patent Publication No. 2006-154626 extracts lyrics from a song, and specifies an incidence time of extracted lyrics, while beforehand associating a plurality of visual effects with time information required for display of the visual effects. Then, the apparatus determines a visual effect based on the extracted lyrics, and adds the visual effect accompanied by motion in accordance with the context of the lyrics of the song.

The visual effect database associates words with visual effects to store. With respect to the visual effect, the apparatus searches the visual database for a word of extracted lyrics, and when the word exists, acquires the visual effect associated with the word and the required time of the visual effect from the visual effect database.

However, in the techniques as described in the above-mentioned documents, it is not possible to set words in portions except a portion to synchronize an image as a query. In the above-mentioned conventional techniques, it is not possible to display an image suited to the entire lyrics or atmospherics of a paragraph, and basically, only words of a part of the lyrics can be used. For example, in reproducing an image in synchronization with music, it is not possible to consider portions (for example, prior and subsequent lyrics) except lyrics in a portion targeted for synchronization reproduction, or consider an impression received from the entire lyrics in image retrieval. As a result, in image retrieval, there is a problem of extracting an image unsuitable for reproducing in synchronization with the lyrics.

### BRIEF SUMMARY OF THE INVENTION

The present invention was made in view of such circumstances, and it is an object of the invention to provide a query extracting apparatus, query extracting method and query extracting program capable of retrieving an image that is suited to a part of lyrics while also having suitability for the other parts.

(1) To attain the above-mentioned object, an image retrieval query extracting apparatus of the invention is a query extracting apparatus to retrieve images suited to lyrics, and is characterized by dividing lyrics targeted for query extraction into a plurality of segments, determining a preferential segment in which a keyword group is preferentially selected from among the segments, and selecting a keyword group to retrieve an image suited to lyrics of the preferential segment while also referring to information of one or more segments. By this means, keywords suited to a single segment are preferentially selected, while referring to the other segments to extract an image retrieval query, and it is thus possible to retrieve an image that is suited to a part of the lyrics while also having suitability for the other parts.

(2) Further, the query extracting apparatus of the invention is characterized by selecting a keyword group to retrieve an image suited to lyrics of the preferential segment by using a line of the lyrics targeted for query extraction as the preferential segment. By this means, it is possible to retrieve an image suitable for each line.

(3) Furthermore, the query extracting apparatus of the invention is characterized by referring to a paragraph of the lyrics targeted for query extraction as the other segment, and selecting a keyword group to retrieve an image suited to lyrics of the preferential segment. By this means, it is possible to retrieve an image in consideration of the paragraph.

(4) Still furthermore, the query extracting apparatus of the invention is characterized by referring to impression information of the entire or part of the lyrics targeted for query extraction as information of the other segments, and selecting a keyword group to retrieve an image suited to lyrics of the preferential segment. By this means, it is possible to retrieve an image in consideration of the impression information.

(5) Moreover, the query extracting apparatus of the invention is characterized by referring to information of two or more mutually different segments as information of the other segments, and selecting a keyword group to retrieve an image suited to lyrics of the preferential segment. By this means, it is possible to retrieve an image in consideration of both of the paragraph and impression information, for example.

(6) Further, the query extracting apparatus of the invention is characterized by selecting as a keyword group for the image retrieval with reference to the degree of importance calculated based on a Web search result. By this means, it is possible to select keywords with effects on image retrieval while reflecting the information on the Web.

(7) Furthermore, the query extracting apparatus of the invention is characterized by repeating a process for selecting a keyword group with one or more hits in an image search on the Web and the maximum number of keywords from a set of keyword groups, and thereby selecting a keyword group to retrieve an image suited to lyrics of the preferential segment. By this means, it is possible to select keywords with effects on image retrieval while reflecting the information on the Web.

(8) Still furthermore, the query extracting apparatus of the invention is characterized by selecting a single keyword group from a power set of keyword groups selected from the preferential segment, and further selecting a keyword group to retrieve an image suited to lyrics of the preferential segment from a set of combinations of a power set of keyword groups selected from the other segments and the selected keyword group. By this means, it is possible to refer to every keyword groups of each segment, and select keywords preferentially from a single segment.

(9) Moreover, the query extracting apparatus of the invention is characterized by extracting a word with (the number of unique image posters)/{log(the number of search hits)} of a high number as a keyword from a set of words that are decomposed from lyrics of the preferential segment or the other segments. By this means, it is possible to extract keywords substantially effective on image retrieval by referring to information on the Web.

(10) Further, the query extracting apparatus of the invention is characterized by retrieving an image on the Web using a keyword group selected to retrieve an image suited to lyrics of the preferential segment as a query, and synchronizing the image obtained as a retrieval result and music corresponding to the lyrics targeted for query extraction to reproduce. By this means, it is possible to reproduce images suited to lyrics in synchronization with the music.

(11) Furthermore, the query extracting apparatus of the invention is a query extracting apparatus to retrieve images suited to lyrics, and is characterized by having a morpheme analyzing section that decomposes lyrics targeted for query extraction into morphemes, a keyword extracting section that extracts keywords from the decomposed morphemes, and a query extracting section which selects, with respect to the lyrics targeted for query extraction divided, a single element from a power set of keyword groups that are decomposed and extracted from a preferential segment in which a keyword group is preferential selected, and which extracts a single combination from combinations of each element of a power set of keyword groups that are decomposed and extracted from the other segments and the selected element, as a query to retrieve an image suited to lyrics of the preferential segment. By this means, it is possible to retrieve an image that is suited to a part of the lyrics while also having suitability for the other parts.

(12) Still furthermore, the query extracting apparatus of the invention is a query extracting apparatus to retrieve images suited to lyrics, and is characterized by having a morpheme analyzing section that decomposes lyrics targeted for query extraction into morphemes, a keyword extracting section that extracts keywords from the decomposed morphemes, and a query extracting section which selects, with respect to the lyrics targeted for query extraction divided, a single element from a power set of keyword groups that are decomposed and extracted from a preferential segment in which a keyword group is preferential selected, and which extracts a single combination from combinations of each element of a power set of keyword groups comprised of impression information of the other segments and the selected element. By this means, it is possible to retrieve an image that is suited to a part of the lyrics while also having suitability for the other parts.

(13) Further, a query extracting method of the invention is a query extracting method to retrieve images suited to lyrics, and is characterized by including the steps of dividing lyrics targeted for query extraction into a plurality of segments, determining a preferential segment in which a keyword group is preferentially selected from among the segments, and selecting a keyword group to retrieve an image suited to lyrics of the preferential segment while also referring to information of one or more segments. By this means, it is possible to retrieve an image that is suited to a part of the lyrics while also having suitability for the other parts.

(14) Furthermore, a query extracting program of the invention is a query extracting program that a computer executes to retrieve images suited to lyrics, and is characterized by including the processing of dividing lyrics targeted for query extraction into a plurality of segments, determining a preferential segment in which a keyword group is preferentially selected from among the segments, and selecting a keyword group to retrieve an image suited to lyrics of the preferential segment while also referring to information of one or more segments. By this means, it is possible to retrieve an image that is suited to a part of the lyrics while also having suitability for the other parts.

According to the invention, it is possible to retrieve an image that is suited to a part of the lyrics while also having suitability for the other parts.

### BRIEF DESCRIPTION OF THE SEVERAL VIEWS OF THE DRAWINGS

FIG. 1 is a diagram illustrating a configuration of a query extracting system of Embodiment 1;

FIG. 2 is a block diagram illustrating a configuration of a query extracting apparatus of Embodiment 1;

FIG. 3 is a flowchart showing an example of the operation of the query extracting apparatus of Embodiment 1;

FIG. 4 is a flowchart illustrating the query extracting operation of Embodiment 1;

FIG. 5 is a conceptual diagram showing an operation example of Embodiment 1;

FIG. 6 is another conceptual diagram showing the operation example of Embodiment 1; and

FIG. 7 is a diagram illustrating a configuration of a query extracting system of Embodiment 2.

### DETAILED DESCRIPTION OF THE INVENTION

Embodiments of the invention will be described below with reference to accompanying drawings. To facilitate the understanding of descriptions, the same structural elements are assigned the same reference numerals in each drawing, and redundant descriptions are omitted.

### Embodiment 1

In the invention, to extract images suitable for the atmospherics of lyrics, keyword candidates are extracted from the lyrics and estimate impression. Further, by extracting an optimal query (keyword group) from the keyword candidates, images suitable for the atmospherics of lyrics are automatically extracted to avoid retrieval of unnecessary images.

### (System Configuration)

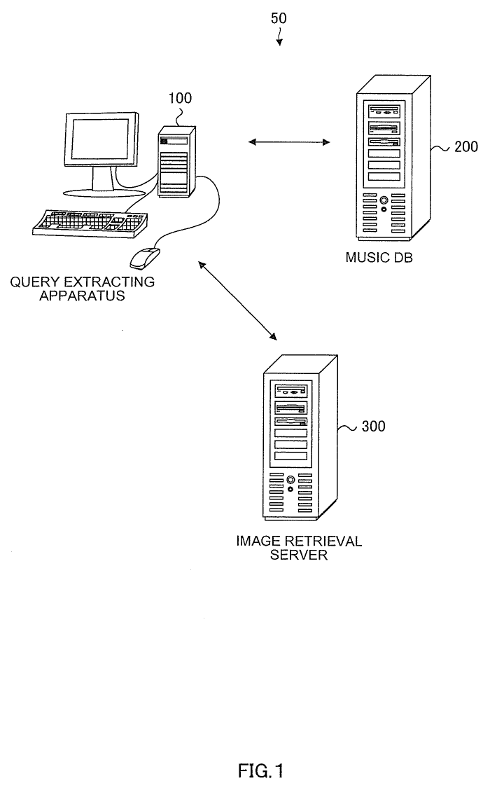

FIG. 1 is a diagram illustrating a configuration of a query extracting system 50. The query extracting system 50 is comprised of a query extracting apparatus 100, music database 200 and image retrieval server 300.

For example, the query extracting apparatus 100 is a PC or portable terminal, and extracts a query to retrieve images suited to lyrics based on the lyrics. The apparatus divides lyrics targeted for query extraction into a plurality of segments, determines a preferential segment in which a keyword group is preferentially selected from among the segments, and selects a keyword group to retrieve an image suited to lyrics of the preferential segment, while also referring to information of one or more segments.

The music database 200 stores music files, lyrics information, lyrics synchronization information, titles, artist information, and music impression information. The music impression information includes an advance questionnaire survey, analysis result based on the questionnaire survey or the like, and is capable of being acquired from information gathering and analysis using existing programs, etc. For example, the impression information on predetermined music is beforehand gathered from ordinary users, and space to divide impression regions is defined based on the gathered data. Then, an impression of new music can be determined based on the lyrics by determining in which impression region in the space the impression is located. In addition, it is assumed that the ranges of lines and paragraphs of lyrics are beforehand designated in the music database 200.

The image retrieval server 300 retrieves images in response to a request from a terminal. For example, the server receives a request by image retrieval API such as GOOGLE API and FLICKR (Trademark) to retrieve images.

### (Configuration of the Query Extracting Apparatus)

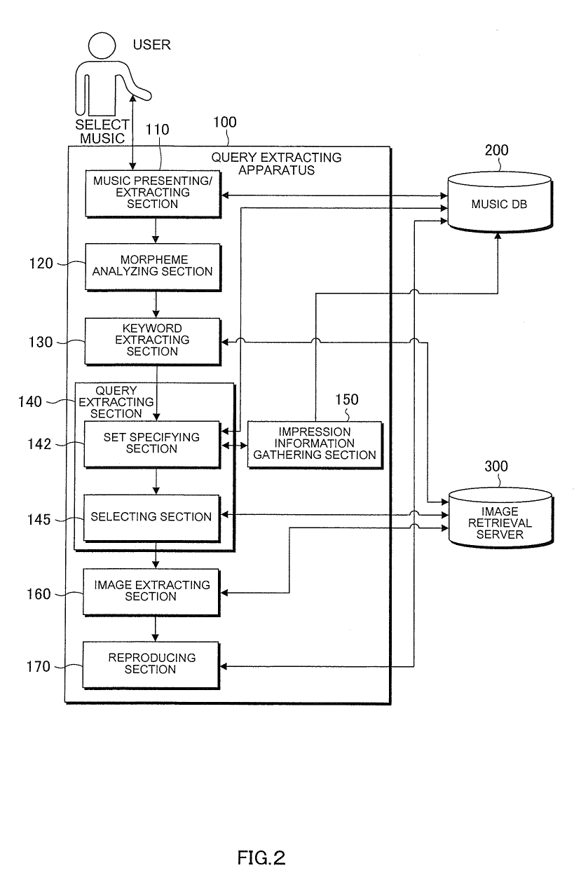

A configuration of the query extracting apparatus 100 will be described below. FIG. 2 is a block diagram illustrating a configuration of the query extracting apparatus 100. As shown in FIG. 2, the query extracting apparatus is provided with a music presenting section 110, morpheme analyzing section 120, keyword extracting section 130, query extracting section 140, impression information gathering section 150, image extracting section 160 and reproducing section 170.

The music presenting section 110 presents music stored in the music database and music targeted for query extraction. The user is capable of designating a presented set.

The morpheme analyzing section 120 performs morpheme analysis on a line-by-line basis from lyrics information of the designated music. However, the analysis does not need to be always performed on a line-by-line basis, and may be performed on a paragraph-by-paragraph basis. For example, it is possible to perform the morpheme analysis by using an open source morpheme analysis engine such as Mecab. In addition, the morpheme analyzing section 120 repeats the processing until the morpheme analysis is performed on all the lines.

The keyword extracting section 130 extracts keywords from morpheme groups obtained in the morpheme analyzing section 120. For example, it is possible to extract all the nouns as keywords. Further, it is not necessary to limit to nouns, and for example, it is also possible to combine adjectives, verbs, etc. to extract. The keyword extracting section 130 extracts words with (the number of unique image posters)/{log(the number of search hits)} of a high number from a set of words decomposed from lyrics of the preferential segment or the other segments. The keyword extracting section 130 extracts words from all the lines of lyrics, and stores an incident line, paragraph number, etc in the lyrics in a database (not shown) for each keyword.

Further, it is not necessary to limit keywords that can be extracted by the keyword extracting section 130 to only lyrics. For example, using an existing impression analysis program or the like, it is possible to use keywords based on the impression of music lyrics. When the aforementioned impression keywords are beforehand stored in the music database 200, the section 130 reads the information from the music database 200.

For example, the keyword extracting section 130 is capable of constructing a set of keywords using (1) nouns occurring in lines, (2) nouns occurring in paragraphs including lines, (3) estimate impression words of the entire music, etc. Using extracted keywords, the keyword extracting section 130 extracts keywords (group) to be candidates for a retrieval request (query) for image retrieval from each line. As a result, it is possible to display an image on a line-by-line basis.

The query extracting section 140 extracts keywords (group) to be a retrieval request (query) for image retrieval for each line from keywords extracted in the keyword extracting section, in order to display an image on a line-by-line basis. As shown in FIG. 2, the query extracting section 140 is further provided with a set specifying section 142 and selecting section 145.

The set specifying section 142 specifies a set of targets for which query extraction for image retrieval is performed with respect to a set of keyword groups. For example, the section 142 specifies only lines of lyrics as “preferential segments”, or specifies a combination of already selected keyword groups and “the other segments” such as paragraphs, etc.

In order that keywords are preferentially selected from a single line (preferential segment) of the lyrics, the selecting section 145 extracts a keyword group to retrieve an image suited to lyrics of the line. At this point, the section 145 is able to refer to also a set of keywords selected from a paragraph of the lyrics and/or the impression information (information of the other segment) of the entire or part of the lyrics.

For example, the selecting section 145 selects a single keyword group from a power set of keyword groups selected from a line, and further selects a keyword group to retrieve an image suited to lyrics of the line from a set of combinations of a power set of keywords selected from paragraphs and the selected keyword group. The section 145 may select a single element from a power set of keyword groups that are decomposed and extracted from a line of the lyrics, and select a single combination from among combinations of each element of a power set of keyword groups comprised of impression information of the lyrics and the selected element. The above-mentioned information of “the other segments” may be information from a single segment, or information of two or more mutually different segments.

The selecting section 145 selects a keyword group (elements of a set of keyword group) as a keyword group for image retrieval, with reference to the degree of importance calculated based on a Web search result. For example, the section 145 repeats the process of selecting a keyword group having one or more hits in the image search on the Web and the maximum number of keywords from a set of keyword groups, and thereby selects a keyword group for image retrieval.

The impression information gathering section 150 gathers the impression image of music from the music database 200. The section 150 requests the impression information to the music database 200 based on information for specifying the music, and is thereby capable of gathering the impression information.

The image extracting section 160 performs image retrieval based on W′max obtained by query extraction processing. For example, using image retrieval API such as GOOGLE API and FLICKR (Trademark), images can be retrieved. The image extracting section 160 extracts an image to synchronize and reproduce from images extracted by the API.

For example, it is possible to extract the most popular image, etc. It is not always necessary to extract only a single image, and a plurality of images can be extracted. Basically, the image extracting section 160 extracts images (group) for all the lines of the lyrics. Further, the image extracting section 160 may perform image extraction at the same time the query extracting section 140 extracts W′max so as not to use the API.

The reproducing section 170 synchronizes an image obtained as a result of retrieval of retrieving images on the Web using the selected keyword group for image retrieval as a query, and music corresponding to the lyrics targeted for query extraction to reproduce. In other words, the reproducing section 170 synchronizes the music on the time series to reproduce, based on the images (group) obtained from the image extracting section 160 and lyrics synchronization information. At this point, the section 170 reads the lyrics synchronization information indicating timing of displaying images from the music database 200, etc.

### (Operation of the Query Extracting Apparatus)

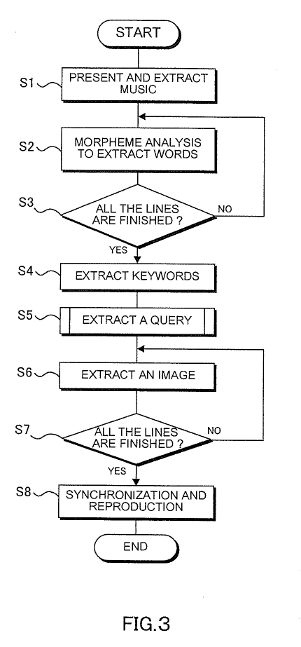

FIG. 3 is a flowchart showing an example of the operation of the query extracting apparatus 100. As shown in FIG. 3, first, the query extracting section 100 presents music stored in the music database 200 to enable designation thereof (step S1). Upon receiving designation of music from the user, the apparatus performs morpheme analysis for each line of the lyrics, and extracts words (step S2). Then, the apparatus determines whether or not word extraction is finished on all the lines (step S3). When it is determined that the extraction is not finished on all the lines, the processing flow returns to step S2.

When it is determined that word extraction is finished on all the lines, the apparatus extracts a set of keywords from a set of extracted words (step S4). An example of keyword extraction criteria will be described later. A query is extracted using a thus extracted set of keywords (step S5). Examples of the query extracting operation and query extraction criteria will be described later. Next, the apparatus retrieves images using the extracted query, and extracts optimal images (step S6). Then, the apparatus synchronizes the extracted images with the music to reproduce (step S7).

### (Query Extracting Operation)

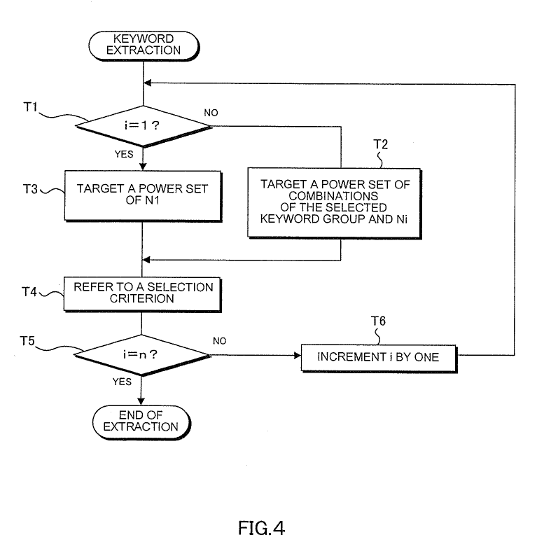

Described next is an example of the query extracting operation in above-mentioned step S5. FIG. 4 is a flowchart illustrating the query extracting operation. In the process of query extraction, it is assumed that a main target to extract a keyword group changes to keyword group sets N1, N2, . . . , Ni . . . , Nn. i is a natural number of n or less.

In the query extracting operation, it is first determined whether or not i=1 (step T1). When it is determined that i=1, a power set of keyword group set N1 is specified as an extraction target for the keyword group (step T2). Meanwhile, when it is not determined that i=1, a combination of keyword groups selected in the previous query extraction process and a power set of keyword group set Ni is specified as an extraction target for the keyword group (step T3).

Next, referring to a criterion described later, a single keyword group is selected from a set of keyword groups that is an extraction target (step T4). Then, it is determined whether or not i=n (step T5). When it is not determined that i=n, i is incremented by one (step T6), and the processing flow returns to step T1. When it is determined that i=n, the operation of query extraction is finished.

In this way, it is possible to automatically extract a query based on features of the lyrics in consideration of the impression information that does not appear in the lyrics and the context of the lyrics. Further, it is not always necessary to extract the query itself from keywords obtained by keyword extraction, and a query can be extracted based on a value of W, for example, from the impression information of the music and/or keywords included in paragraphs. In addition, the aforementioned operation is executed by a program.

### (Keyword Extraction Criterion)

When keywords obtained by keyword extraction are used without modification, since many unintended images may be obtained, it is necessary to extract keywords suitable for retrieval. For example, keywords are input using image retrieval API or the like based on keywords, the number of unique image poster IDs (UF) and the number of retrieval hits (DF) included in a retrieval result image group are acquired as parameters, and importance is calculated using equation (1).

$$W = \frac{UF}{log ( DF )} \qquad ( Eq . 1 )$$

Using this equation, it can be judged that the importance is higher as a value of W is higher. Finally, words with W of a threshold or more are extracted as keywords in descending order of W or the like. For example, it is possible to set a value of W as a threshold when UF=10 and DF=40. However, this is an example, and a method of selecting a threshold is not limited thereto. For example, parameters can be calculated using image retrieval API such as GOGGLE API and FLICKR (Trademark). In this way, keywords are extracted for each line from the lyrics.

### (Query Extraction Criterion)

The query extracting section 140 is capable of calculating a combination to extract an optimal query group for image retrieval from input keyword groups. An example of query extraction criteria will be described below.

(1) In a power set P (N1)={W1, 1, W1, 2, . . . , W1, x} of keyword group set N1, Wmax is selected that meets DF(W1, i)≧1 and that maximizes |W1, i|. Herein, |W| represents the number of elements (the number of nouns) constituting a word set W. When there is a plurality of Wmax, selected is Wmax such that UF(Wmax) is the maximum. Thus selected Wmax is assumed to be line query set Qline.

(2) In a set P′(N2)={W2, 1uQline, W2, 2uQline, . . . , W2, yuQline}={W2, 1, W′ 2, 2 . . . , W′ 2, y} obtained by adding Qline to each element of a power set P (N2)={W2, 1, W2, 2, . . . , W2, y} of keyword group set N2, W′ max is selected by the same processing as in 1. In addition, AND search may be further performed using all the elements of W′max and image retrieval API.

### Operation Example

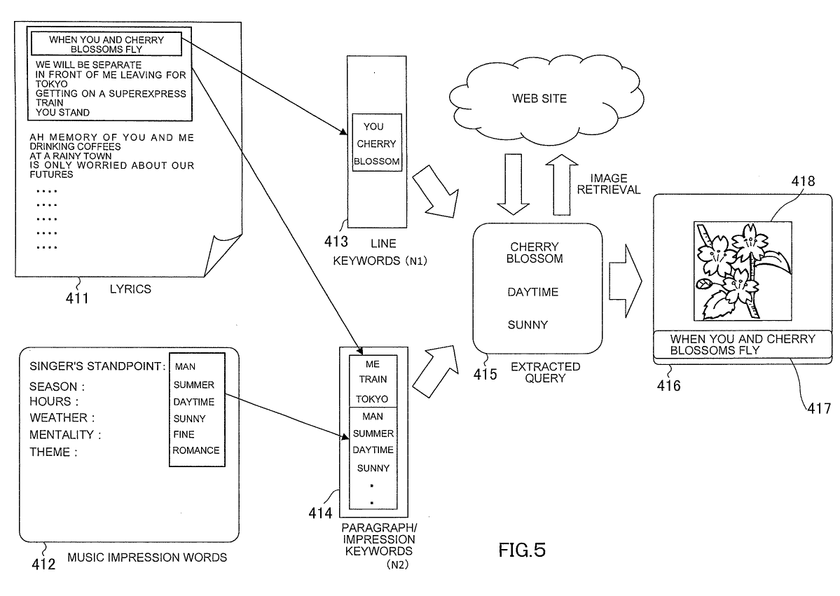

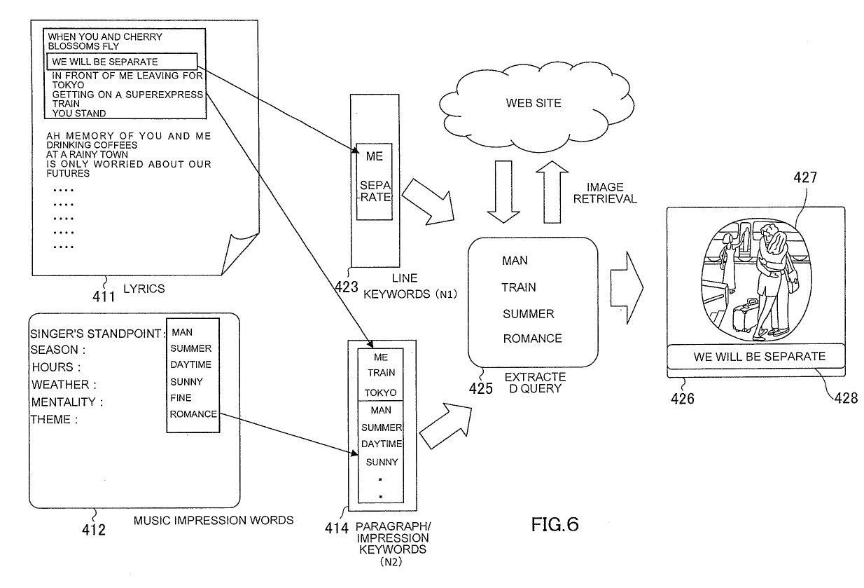

Described next is an example in which images are specifically retrieved using the lyrics, and the music and images are synchronized and reproduced. FIGS. 5 and 6 are conceptual diagrams showing an operation example. In the example as shown in FIGS. 5 and 6, images are retrieved and extracted respectively for the first line and second line of lyrics 411, and extracted images are displayed for each line of the lyrics.

First, as shown in FIG. 5, the query extracting apparatus 100 performs morpheme analysis on the first line “when you and cherry blossoms fly” of the lyrics 411, and extracts “you”, “cherry” and “blossom” as line keywords 413 (keyword group set N1). Meanwhile, as paragraph/impression keywords 414 (keyword group set N2), the apparatus 100 extracts “I”, “train” and “Tokyo” from the first paragraph, and further extracts “man”, “summer”, “daytime”, “sunny”, “fine” and “romance” from music impression words of the entire lyrics.

Then, the apparatus 100 selects a keyword group with one or more hits in image retrieval and the high number of keywords from a power set of the line keywords 413 of “you”, “cherry” and “blossom”. Then, the apparatus 100 selects a keyword group with one or more hits in image retrieval and the high number of keywords from a power set of combinations of the keyword group that is the selection result and paragraph/impression keywords 414. As a result, as an extracted query 415, for example, the apparatus 100 is capable of extracting a keyword group of “cherry”, “daytime” and “sunny”. Then, image retrieval is performed on Web sites, and it is possible to extract an optimal image 418. Then, in reproducing, as screen display 416, it is possible to synchronize and reproduce the image 418 and line 417 of the lyrics.

With respect to FIG. 6, similarly, morpheme analysis is performed on the second line “we will be separate” of the lyrics 411, and “I” and “separate” are extracted as the line keywords 413 (keyword group set N1). The same set as in the first line can be used as the paragraph/impression keywords 414 (keyword group set N2).

Then, the apparatus 100 selects a keyword group with one or more hits in image retrieval and the high number of keywords from a power set of the line keywords 423 of “I” and “separate”. Then, the apparatus 100 selects a keyword group with one or more hits in image retrieval and the high number of keywords from a power set of combinations of the keyword group that is the selection result and paragraph/impression keywords 414. As a result, as an extracted query 425, for example, the apparatus 100 is capable of extracting a keyword group of “man”, “train”, “summer” and “romance”. Then, image retrieval is performed on Websites, and it is possible to extract an optimal image 428. Then, in reproducing, as screen display 426, it is possible to synchronize and reproduce the image 428 and line 427 of the lyrics. By repeating such operation, it is possible to extract images suitable for each line of the lyrics, and synchronize and reproduce the images with the music.

### Embodiment 2

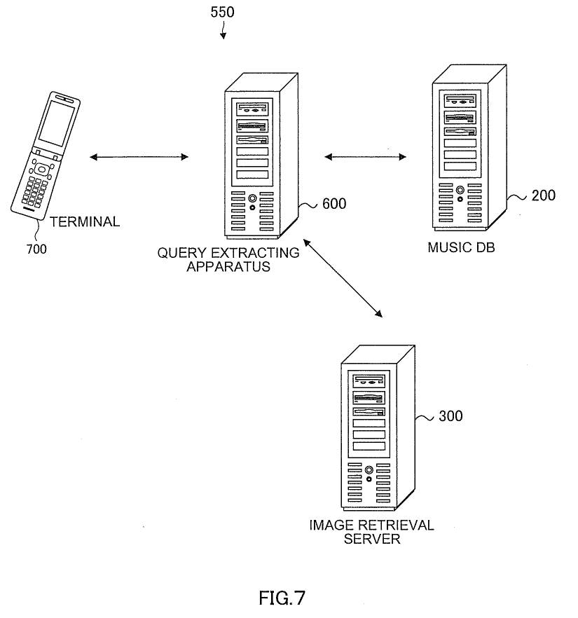

In the above-mentioned Embodiment, the query extracting apparatus is a PC or portable terminal, but may be a server. FIG. 7 is a diagram illustrating a configuration of a query extracting system 550 in which a query extracting apparatus 600 functions as a server. As shown in FIG. 7, the query extracting system 550 is provided with the query extracting apparatus 600, terminal 700, music database 200 and image retrieval server 300. In this Embodiment, the query extracting apparatus 600 extracts a query and retrieves images as a server, and the terminal 700 receives the result. Then, the terminal 700 synchronizes and reproduces the extracted images and music. Such a system is effective when the processing capability of the terminal 700 is low.

In addition, in the above-mentioned Embodiments, the “preferential segment” is a single line, but may be two lines, three lines or a half line. Further, “the other segments” are the entire lyrics and paragraphs, but may be a segment of the verse of the lyrics, a half paragraph or a line. Furthermore, in the above-mentioned Embodiments, the music database 200 is an apparatus outside the query extracting apparatus, but may be provided inside the query extracting apparatus.

1. A query extracting apparatus to retrieve images suited to lyrics,
wherein the apparatus divides lyrics targeted for query extraction into a plurality of segments,
determines a preferential segment, in which a keyword group is preferentially selected, from among the segments, and selects a keyword group to retrieve an image suited to lyrics of the preferential segment, while also referring to information of one or more segments.

2. The query extracting apparatus according to claim 1, wherein the apparatus selects a keyword group to retrieve an image suited to the lyrics of the preferential segment by using a line of the lyrics targeted for query extraction as the preferential segment.

3. The query extracting apparatus according to claim 1, wherein the apparatus refers to a paragraph of the lyrics targeted for query extraction as the other segment, and selects a keyword group to retrieve an image suited to the lyrics of the preferential segment.

4. The query extracting apparatus according to claim 1, wherein the apparatus refers to impression information of the entire or part of the lyrics targeted for query extraction as information of the other segments, and selects a keyword group to retrieve an image suited to the lyrics of the preferential segment.

5. The query extracting apparatus according to claim 1, wherein the apparatus refers to information of two or more mutually different segments as information of the other segments, and selects a keyword group to retrieve an image suited to the lyrics of the preferential segment.

6. The query extracting apparatus according to claim 1, wherein the apparatus selects the keyword group for image retrieval with reference to the degree of importance calculated based on a Web search result.

7. The query extracting apparatus according to claim 6, wherein the apparatus repeats a process for selecting a keyword group with one or more hits in an image search on the Web and the maximum number of keywords from a set of keyword groups, and thereby selects the keyword group to retrieve an image suited to the lyrics of the preferential segment.

8. The query extracting apparatus according to claim 1, wherein the apparatus selects a single keyword group from a power set of keyword groups selected from the preferential segment, and
further selects a keyword group to retrieve an image suited to the lyrics of the preferential segment from a set of combinations of a power set of keyword groups selected from the other segments and the selected keyword group.

9. The query extracting apparatus according to claim 1, wherein the apparatus extracts a word with (the number of unique image posters)/{log(the number of search hits)} of a high number as a keyword from a set of words that are decomposed from the lyrics of the preferential segment or the other segments.

10. The query extracting apparatus according to claim 1, wherein the apparatus retrieves an image on the Web using a keyword group selected to retrieve an image suited to the lyrics of the preferential segment as a query, and synchronizes the image obtained as a retrieval result and music corresponding to the lyrics targeted for query extraction to reproduce.

11. A query extracting apparatus to retrieve images suited to lyrics, comprising:
a morpheme analyzing section that decomposes lyrics targeted for query extraction into morphemes;
a keyword extracting section that extracts keywords from the decomposed morphemes; and
a query extracting section which selects, with respect to the lyrics targeted for query extraction divided, a single element from a power set of keyword groups that are decomposed and extracted from a preferential segment in which a keyword group is preferential selected, and which extracts a single combination from combinations of each element of a power set of keyword groups that are decomposed and extracted from the other segments and the selected element, as a query to retrieve an image suited to the lyrics of the preferential segment.

12. A query extracting apparatus to retrieve images suited to lyrics, comprising:
a morpheme analyzing section that decomposes lyrics targeted for query extraction into morphemes;
a keyword extracting section that extracts keywords from the decomposed morphemes; and
a query extracting section which selects, with respect to the lyrics targeted for query extraction divided, a single element from a power set of keyword groups that are decomposed and extracted from a preferential segment in which a keyword group is preferential selected, and which extracts a single combination from combinations of each element of a power set of keyword groups comprised of impression information of the other segments and the selected element.

13. A query extracting method to retrieve images suited to lyrics, comprising:
dividing lyrics targeted for query extraction into a plurality of segments;
determining a preferential segment, in which a keyword group is preferentially selected, from among the segments; and
selecting a keyword group to retrieve an image suited to lyrics of the preferential segment, while also referring to information of one more segments.

14. A query extracting program that a computer executes to retrieve images suited to lyrics, including the processing of:
dividing lyrics targeted for query extraction into a plurality of segments;
determining a preferential segment, in which a keyword group is preferentially selected, from among the segments; and
selecting a keyword group to retrieve an image suited to lyrics of the preferential segment, while also referring to information of one or more other segments.
